(19) United States
(12) Patent Application Publication
(10) Pub. No.: US 2026/0289606 A1
(43) Pub. Date: Sep. 24, 2026

(54) ADVERTISEMENT DISPLAY DEVICE, ADVERTISEMENT DISPLAY METHOD, AND NON-TRANSITORY COMPUTER-READABLE MEDIUM

(71) Applicant: NEC Corporation, Tokyo (JP)

(72) Inventors: Yasuhiko YOSHIDA, Tokyo (JP); Rui KONDO, Tokyo (JP); Shinnosuke NISHIMOTO, Tokyo (JP)

(73) Assignee: NEC Corporation, Tokyo (JP)

(21) Appl. No.: 19/532,277

(22) Filed: Feb. 6, 2026

(30) Foreign Application Priority Data
Mar. 18, 2025 (JP) 2025-043981

(51) Int. Cl. G06Q 30/0251; G06F 3/01; G06F 3/16; G06Q 10/40

(52) U.S. Cl. CPC G06Q 30/0261; G06F 3/013; G06Q 10/40; G06F 3/167

(57) ABSTRACT

There is provided an advertisement display device for displaying an advertisement in a metaverse space including a predetermined range user specifying unit for confirming positions of a plurality of users and specifying a user within a predetermined range of an advertisement, a same friend group user specifying unit for specifying users belonging to a same friend group from among users within the predetermined range, and an advertisement synchronization display unit for synchronously displaying an advertisement to users belonging to the same friend group.

### INCORPORATION BY REFERENCE

This application is based upon and claims the benefit of priority from Japanese patent application No. 2025-043981, filed on Mar. 18, 2025, the disclosure of which is incorporated herein in its entirety by reference.

### TECHNICAL FIELD

The present disclosure relates to an advertisement display device, an advertisement display method, and a non-transitory computer-readable medium.

### BACKGROUND ART

JP 2014-67401 A discloses a method of providing an advertisement based on a gaze of a user.

### SUMMARY

However, there is no disclosure of a device that provides an advertisement based on a gaze in a metaverse space. Therefore, an example object of the present disclosure is to provide an advertisement display device that provides an advertisement based on a gaze in a metaverse space and with which a plurality of users share an experience.

An advertisement display device of an example aspect of the present disclosure is an advertisement display device for displaying an advertisement in a metaverse space, the advertisement display device including
a memory for storing a program, and
a processor for processing the program to execute,
confirming positions of a plurality of users and specifying a user within a predetermined range of an advertisement,
specifying users belonging to a same friend group from among users within the predetermined range, and
synchronously displaying an advertisement to users belonging to the same friend group.

An advertisement display method of an example aspect of the present disclosure is an advertisement display method for displaying an advertisement in a metaverse space, the method including
confirming positions of a plurality of users and specifying a user within a predetermined range of an advertisement,
specifying users belonging to a same friend group from among users within the predetermined range, and
synchronously displaying an advertisement to users belonging to the same friend group.

A non-transitory computer-readable medium of an example aspect of the present disclosure is a non-transitory computer-readable medium storing a program for displaying an advertisement in a metaverse space, the program causing an information processing device to execute:
confirming positions of a plurality of users and specifying a user within a predetermined range of an advertisement,
specifying users belonging to a same friend group from among users within the predetermined range, and
synchronously displaying an advertisement to users belonging to the same friend group.

According to an example advantage of the present disclosure, an advertisement display device that provides an advertisement based on a gaze in a metaverse space and with which a plurality of users share an experience can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an outline of a metaverse space according to the present disclosure;

FIG. 2 is a diagram illustrating display of an advertisement in the metaverse space according to the present disclosure;

FIG. 3 is a block diagram illustrating a configuration of an advertisement display device according to the present disclosure;

FIG. 4 is a flowchart of an advertisement display method according to the present disclosure; and

FIG. 5 is a block diagram illustrating a configuration of an information processing device according to the present disclosure.

### EXAMPLE EMBODIMENTS

### Description of Metaverse Space According to Example Embodiment

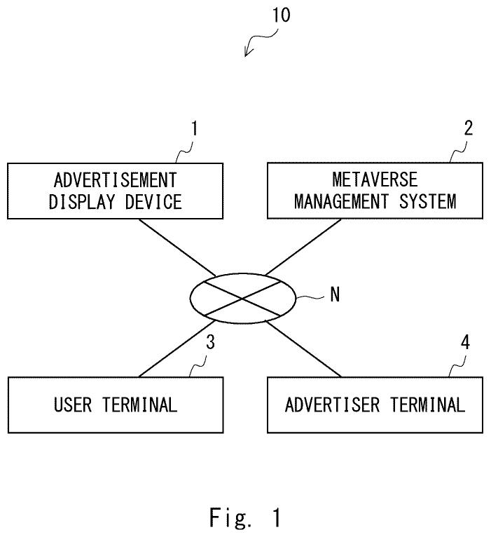

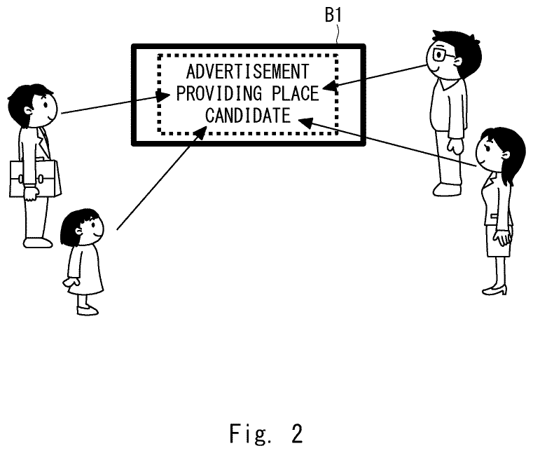

FIG. 1 is a diagram illustrating an outline of a metaverse space according to the present disclosure. FIG. 2 is a diagram illustrating a display of an advertisement in the metaverse space according to the present disclosure. A metaverse space according to an example embodiment will be described with reference to FIGS. 1 and 2.

The metaverse space is a three-dimensional virtual space constructed on the Internet. The metaverse space can create a place to chat with voice or text by posting a space in which an individual arranges objects according to preference. The metaverse space creates an atmosphere such as academic, realistic, cyberpunk, lovely, urban, natural, and the like, and accepts access from a person who likes the atmosphere.

As illustrated in FIG. 1, a metaverse 10 includes an advertisement display device 1, a metaverse management system 2, a user terminal 3, an advertiser terminal 4, and the like connected via a network N. The metaverse 10 may be connected to a metaverse poster terminal. The network N is the Internet such as a telephone line or an electric communication line.

The advertisement display device 1 is a device that displays an advertisement in a metaverse space created by an individual. The advertisement is a moving image or a still image with voice or without voice. Here, the advertisement is usually displayed in synchronization with the gaze of the user. However, as illustrated in FIG. 2, the advertisement display device 1 includes a display object B1 that synchronously displays advertisements to users belonging to the same friend group. The same friend group is a group of a plurality of users registered as friends.

The metaverse management system 2 provides the metaverse space to an individual poster. The individual poster arranges objects in the metaverse space through the metaverse poster terminal. The creation of the atmosphere of the metaverse space is basically left to the discretion of an individual.

The user terminal 3 is a terminal of an individual that can enter a specific metaverse space and perform a chat or the like. The user can operate his/her own avatar in the metaverse space by using a Personal Computer (PC), a portable terminal, a head mounted display, or the like. On the screen of the user terminal 3, the visual field of the avatar is displayed in a first-person view or a third-person view. For example, in a case where the user terminal 3 is a head mounted display, the user terminal 3 detects the movement of the head of the user and moves the visual field of the avatar. The head mounted display may also be able to track the gaze by tracking the movement of the user's iris.

As illustrated in FIG. 2, an advertisement may be reproduced in a case where a display object B1 imitating a display installed in the metaverse space is displayed on the display screen of the user terminal 3. The display portion of the advertisement may be determined by a direction at the time the user wearing the character or the head mounted display moves the face back and forth and left and right. In the metaverse space, the advertisement can be set to be distributed to the display object in a case where the display object B1 detects the gaze.

The advertiser terminal 4 is a terminal managed by an advertiser that inputs an advertisement. Normally, the advertisement is controlled to be displayed according to the display portion or the gaze of the user. However, the users belonging to the same friend group want to share the experience in the metaverse space including the advertisement. Therefore, for users belonging to the same friend group, a device that synchronously sends an advertisement to the metaverse space is desired.

### Description of Advertisement Display Device According to First Example Embodiment

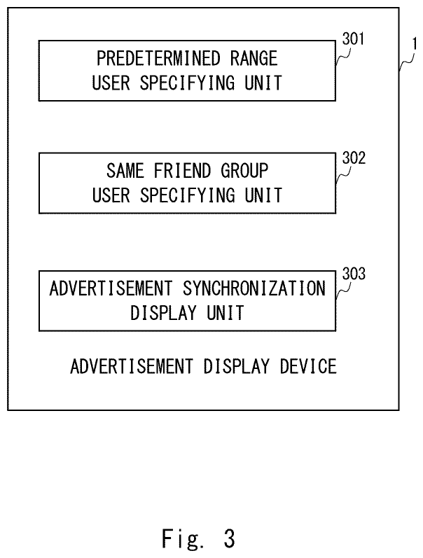

FIG. 3 is a block diagram illustrating a configuration of the advertisement display device according to the present disclosure. The advertisement display device according to the example embodiment will be described with reference to FIG. 3. The display device according to the example embodiment is a device that runs an advertisement to the metaverse space in synchronization with respect to users belonging to the same friend group.

As illustrated in FIG. 3, the advertisement display device 1 according to the example embodiment includes a predetermined range user specifying unit 301, a same friend group user specifying unit 302, and an advertisement synchronization display unit 303.

The predetermined range user specifying unit 301 confirms positions of a plurality of users, and specifies a user within a predetermined range of the advertisement. In the metaverse space, there are a plurality of users who participate in or do not participate in the friend group. The predetermined range user specifying unit 301 specifies a plurality of users within a predetermined range of the advertisement display unit of the metaverse space. The predetermined range may be considered as a range in which the user can recognize the advertisement. If the distance is too far, the user cannot recognize the advertisement even if the advertisement is displayed.

The same friend group user specifying unit 302 specifies users belonging to the same friend group from among the users within a predetermined range. The same friend group user specifying unit 302 specifies users in the same friend group from among the users within a predetermined range of the advertisement. Specifically, the same friend group user specifying unit 302 may acquire whether users within a predetermined range are registered as being in the same group with each other by a matching function, a friend registration function, or the like provided on the virtual space. Then, the same friend group user specifying unit 302 may determine whether the users in a predetermined range are in the same friend group according to whether the users are registered as being in the same group by the above function.

Furthermore, the same friend group user specifying unit 302 may determine whether users within a predetermined range are in the same friend group according to the attributes registered by the users. The attribute is, for example, the gender, age, interest/preference, and place of residence of the user. In addition, the attribute is not limited to an item that the user actively registers, and also includes an action history and an item automatically collected from a platform on the virtual space such as a frequently used service.

Furthermore, the same friend group user specifying unit 302 may determine whether users within a predetermined range are in the same friend group based on the user ID. For example, the same friend group user specifying unit 302 acquires an action history of each user associated with each user ID from a plurality of users within a predetermined range. Then, in a case where the users often act together in the virtual space, the same friend group user specifying unit 302 may specify the plurality of users as the same friend group users.

The advertisement synchronization display unit 303 synchronously displays the advertisement to users belonging to the same friend group. The advertisement usually starts to be displayed according to the gaze of the user. However, here, advertisements are synchronized with respect to the users of the same friend group, so that experiences can be shared. For example, the advertisement synchronization display unit 303 starts an advertisement in case where gazes of the users in the same friend group are aligned.

The advertisement synchronization display unit 303 may start reproduction of the advertisement in a case where all the users of the same friend group look at the advertisement. Furthermore, the advertisement synchronization display unit 303 may start reproduction of the advertisement in a case where some of the users of the same friend group look at the advertisement. For example, the advertisement synchronization display unit 303 may start reproduction of the advertisement in a case where eight out of ten people look at the installed location of the advertisement. In this case, the advertisement synchronization display unit 303 may display a still image, a predetermined moving image, or the like in a state where one to seven people are looking at the installed location of the advertisement. Then, the advertisement synchronization display unit 303 may reproduce the moving image of the actual advertisement in a case where the eighth person looks at the advertisement.

For example, in a case where one to seven people or less out of 10 people view the installed location of the advertisement, the advertisement synchronization display unit 303 may start reproduction of the advertisement at the timing each user views the installed location. Then, in a case where the eighth person looks at the installed location, the advertisement synchronization display unit 303 may stop the reproduction of the advertisement viewed by each user, and perform a control such that the advertisement displayed to each user is reproduced from the beginning at the same timing.

As the number of users looking at the advertisement increases, the advertisement synchronization display unit 303 may increase the number of displays of the advertisement, change the content, or display privilege information such as a coupon. For example, as the number of people looking at the advertisement increases, the display content of the advertisement may increase, the content is changed to a more interesting content, or privilege information such as a coupon may increase. The above configuration serves as a trigger for showing the advertisement to many users.

A change according to an increase in the number of people gazing will be described. For example, in a case where one person is carefully observing, normal advertisement display or still image display is performed. In a case where two to five people are carefully observing, privilege information or a discount coupon is displayed, or a simple animation such as movement of a background or blinking of a text is displayed. In a case where six or more people are carefully observing, special content such as a limited video or a lottery game starts, a video is switched, more detailed information is added, or a full animation or interactive content is reproduced.

The change of the video according to the gaze concentration degree, that is the stay time of the gaze, will be described. For example, if the average stay time of the gaze is less than one second, normal advertisement display or still image display is performed. In a case where the average stay time of the gaze is one or more seconds and less than five seconds, privilege information or a discount coupon is displayed, or a simple animation such as movement of a background or blinking of a text is displayed. In a case where the average stay time of the gaze is equal to or longer than five seconds, special content such as a limited video or a lottery game starts, the video is switched, more detailed information is added, or a full animation or interactive content is reproduced.

In addition, the video may be changed by multiplying an increase in the number of gazes and a stay time of the gaze.

Furthermore, the advertisement synchronization display unit 303 may change the voice. For example, in a case where the gaze stay time is less than one second or in a case where one person is carefully observing, voice is turned off. In a case where the gaze stay time is one or more seconds and less than five seconds or in a case where two to five people are carefully observing, a sound effect such as, for example, a light chime sound is added. In a case where the gaze stay time is equal to or longer than five seconds or five or more people are carefully observing, a narration flows, and a more detailed description is provided. The number of gazes and the gaze stay time may be determined separately, or may be determined by multiplying the two.

Furthermore, the advertisement synchronization display unit 303 may change music or BGM. For example, the volume or tempo of the BGM changes as the number of gazes increases. For example, the tempo of the BGM is increased with three or more gazes. In a case where a specific gaze pattern is detected, such as viewing a specific area for a certain period of time, a special sound effect may be reproduced.

The provision of the reward or the privilege according to the gaze concentration degree will be described. For example, in a case where the gaze stay time is equal to or longer than five seconds or equal to or more than five people, a discount coupon is displayed, or a present lottery according to the number of people who have caught their gaze is started. In a case where the gaze stay time is equal to or longer than ten seconds or equal to or more than ten people, a coupon with a higher discount amount or discount rate is provided, or the lottery probability is increased. The number of gazes and the gaze stay time may be determined separately, or may be determined by multiplying the two.

The change of the interactive element related to the gaze concentration degree will be described. A change based on a pattern of gaze movement is conceivable. For example, in a case where the gazes of a plurality of people of equal to or more than five people remain in a certain area, detailed information regarding the area is displayed in an enlarged manner. Alternatively, for example, in a case where the gazes of a plurality of people of equal to or more than five people move in the screen over a plurality of times, it is determined that the user's interests are distributed over a wide range, and a content list for each category is displayed. Alternatively, for example, in a case where the gazes of a plurality of people of equal to or more than five people are maintained for equal to or more than two seconds on a certain button or area, that button is selected and the next content is displayed. This can be said to be a non-contact interface using gaze tracking. Alternatively, for example, in a case where gazes of a plurality of people of equal to or more than five people look at the entire screen for a certain period of time, the content automatically transitions to the next content.

The gaze of the user is acquired by a screen display unit or gaze tracking. Specifically, a screen displayed on a display such as a monitor and a head mounted display used by the user can be acquired as the gaze of the user. In other words, the visual field of the avatar or the like operated by the user on the virtual space can be acquired as the gaze of the user. Furthermore, in a case where a gaze can be tracked by a gaze tracking device of the head mounted display, the gaze may be acquired.

The predetermined range user specifying unit 301, the same friend group user specifying unit 302, and the advertisement synchronization display unit 303 may be reread as a predetermined range user specifying means, a same friend group user specifying means, and an advertisement synchronization display means.

With the above configuration, an advertisement display device that provides an advertisement based on a gaze in a metaverse space and with which a plurality of users share an experience can be provided.

### Description of Advertisement Display Method According to Example Embodiment

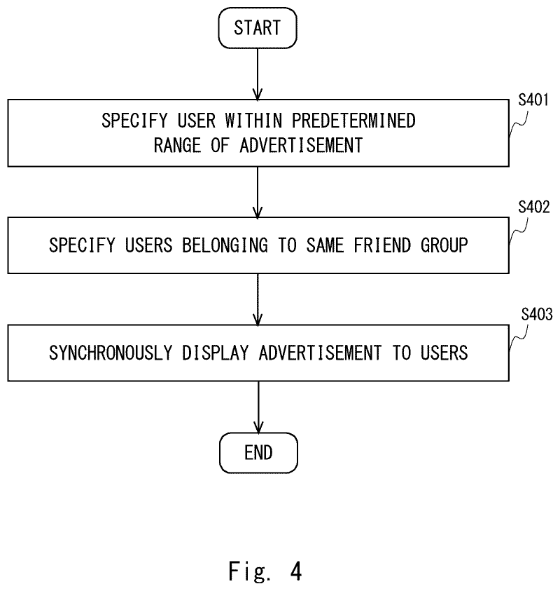

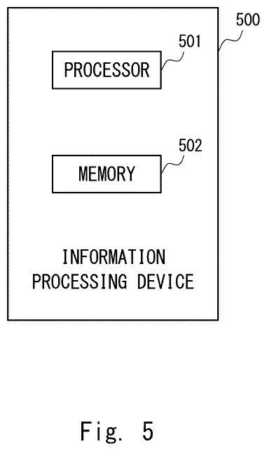

FIG. 4 is a flowchart of an advertisement display method of the present disclosure. FIG. 5 is a block diagram illustrating a configuration of an information processing device according to the present disclosure. An advertisement display method according to the example embodiment will be described with reference to FIGS. 4 and 5.

As illustrated in FIG. 4, first, a user within a predetermined range of the advertisement is specified (step S401). The predetermined range user specifying unit 301 confirms positions of a plurality of users, and specifies a user within a predetermined range of the advertisement. Next, users belonging to the same friend group are specified (step S402). The same friend group user specifying unit 302 specifies users belonging to the same friend group from among the users within a predetermined range.

Lastly, the advertisement is synchronously displayed to the users (step S403). The advertisement synchronization display unit 303 synchronously displays the advertisement to users belonging to the same friend group as described in the above description of the advertisement synchronization display unit 303.

With the above configuration, an advertisement display method that provides an advertisement based on a gaze in a metaverse space and with which a plurality of users share an experience can be provided.

The above method is executed by executing a program in the information processing device and performing processing. As illustrated in FIG. 5, an information processing device 500 includes a processor 501 for physically executing a program to perform processing, and a memory 502 for storing the program. The information processing device 500 may include one device or a plurality of devices. The information processing device 500 may be a cloud server that processes some or all of the functions in a distributed manner. The information processing device 500 may be reread as the advertisement display device 1.

Some or all of the processing in the advertisement display device 1 and the information processing device 500 described above can be achieved as a computer program. Such a program can be stored using various types of non-transitory computer-readable medium and supplied to the computer. The non-transitory computer-readable medium includes various types of tangible recording media. Examples of the non-transitory computer-readable medium includes a magnetic recording medium (e.g., a flexible disk, a magnetic tape, or a hard disk drive), a magneto-optical recording medium (e.g., a magneto-optical disc), a CD-Read Only Memory (ROM), a CD-R, a CD-R/W, and a semiconductor memory (e.g., a mask ROM, a Programmable ROM (PROM), an Erasable PROM (EPROM), a flash ROM, or a Random Access Memory (RAM). The program may be supplied to the computer using various types of transitory computer-readable media. Examples of the transitory computer-readable media include electric signals, optical signals, and electromagnetic waves. The transitory computer-readable medium can supply the programs to the computer via a wired communication path such as an electric wire and an optical fiber or a wireless communication path.

### Description of Advertisement Display Device According to Another Example Embodiment

The advertisement display device 1 can take various forms. An example thereof will be described below.

First, the advertisement display device 1 may include an advertisement stopping unit for stopping the operation of the advertisement in a case where the gaze of the user deviates from the advertisement. The advertisement stopping unit may stop the operation of the advertisement in a case where some or all of the gazes of the users included in the same friend group deviate from the advertisement. In this way, it is possible to stop the advertisement that does not attract the user's interest.

The advertisement display device 1 adds voice at the start of an advertisement to attract the attention of the users belonging to the same friend group. The voice may be a mechanical caution sound or a voice such as “advertisement will start now”. In this way, advertisement display synchronization is easily performed.

The advertisement display device 1 may be set such that the advertisement includes educational information, and additional information or a quiz is displayed by continuing to look at the advertisement. In this way, it is possible to present the participatory advertisement to make the user interested in the advertisement.

The advertisement synchronization display unit 303 may have a function of transitioning to the purchase page of the advertisement according to the consensus of the users belonging to the same friend group. The purchase page may be an external homepage, but it is preferable that there is a shop on the metaverse space. The users who shared the advertisement can purchase the product together.

The advertisement synchronization display unit 303 may have a function of displaying a 3D advertisement object in such a way as to face the front side for each user. In a normal space, a 3D advertisement object is displayed differently depending on a viewpoint of a user. However, in the metaverse space, it is also possible to change the direction of the 3D advertisement object for each viewpoint. A plurality of users can share an advertisement experience by causing the 3D advertisement object to face the front side for each user. Depending on the setting, the 3D advertisement may be viewed from each viewpoint.

In a case where one of the users belonging to the same friend group looks at the advertisement, the advertisement synchronization display unit may start to operate the advertisement also in other users belonging to the same friend group that are not within a predetermined range, or may start the operation in a case where all the users belonging to the same friend group enter within the predetermined range. This is one of the methods for the users to share an advertisement experience.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments may be described as the following Supplementary Notes, but are not limited to the following.

### Supplementary Note 1

An advertisement display device for displaying an advertisement in a metaverse space, the advertisement display device including,
a predetermined range user specifying means for confirming positions of a plurality of users and specifying a user within a predetermined range of an advertisement,
a same friend group user specifying means for specifying users belonging to a same friend group from among users within the predetermined range, and
an advertisement synchronization display means for synchronously displaying an advertisement to users belonging to the same friend group.

### Supplementary Note 2

The advertisement display device according to supplementary note 1, further including an advertisement stopping unit for stopping an operation of an advertisement in a case where a gaze of the user deviates from the advertisement.

### Supplementary Note 3

The advertisement display device according to supplementary note 2, in which the gaze of the user is acquired by screen display or gaze tracking.

### Supplementary Note 4

The advertisement display device according to supplementary note 1, in which a voice is added at a start of the advertisement to attract attention of users belonging to the same friend group.

### Supplementary Note 5

The advertisement display device according to supplementary note 1, in which
the advertisement includes educational information, and
additional information or a quiz is displayed by continuing to look at the advertisement.

### Supplementary Note 6

The advertisement display device according to supplementary note 1, in which the advertisement synchronization display unit has a function of transitioning to a purchase page of the advertisement by a consensus of users belonging to the same friend group.

### Supplementary Note 7

The advertisement display device according to supplementary note 1, in which the advertisement synchronization display unit has a function of displaying a 3D advertisement object in such a way as to face front side for each user.

### Supplementary Note 8

The advertisement display device according to supplementary note 1, in which in a case where one of the users belonging to the same friend group looks at the advertisement, the advertisement synchronization display unit starts an operation of the advertisement also for other users belonging to the same friend group that are not within a predetermined range, or starts the operation in a case where all the users belonging to the same friend group are within the predetermined range.

### Supplementary Note 9

An advertisement display method for displaying an advertisement in a metaverse space, the method including,
confirming positions of a plurality of users and specifying a user within a predetermined range of an advertisement,
specifying users belonging to a same friend group from among users within the predetermined range, and
synchronously displaying an advertisement to users belonging to the same friend group.

### Supplementary Note 10

A program for displaying an advertisement in a metaverse space, the program causing an information processing device to execute
confirming positions of a plurality of users and specifying a user within a predetermined range of an advertisement,
specifying users belonging to a same friend group from among users within the predetermined range, and
synchronously displaying an advertisement to users belonging to the same friend group.

Some or all of the elements (e.g., configurations and functions) described in Supplementary Notes 2 to 8 dependent on Supplementary Note 1 {e.g. device} can also be dependent on Supplementary Note 9 {e.g. method} and Supplementary note 10 {e.g. program} by the dependency relationship similar to those of Supplementary Notes 2 to 8. Some or all of the elements described in any Supplementary Note may be applied to various types of hardware, software, recording means for recording software, systems, and methods.

What is claimed is:

1. An advertisement display device for displaying an advertisement in a metaverse space, the advertisement display device comprising:
a memory for storing a program; and
a processor for processing the program to execute,
confirming positions of a plurality of users and specifying a user within a predetermined range of an advertisement;
specifying users belonging to a same friend group from among users within the predetermined range; and
synchronously displaying an advertisement to users belonging to the same friend group.

2. The advertisement display device according to claim 1, wherein the processor executes stopping an operation of an advertisement in a case where a gaze of the user deviates from the advertisement.

3. The advertisement display device according to claim 2, wherein a gaze of the user is acquired by screen display or gaze tracking.

4. The advertisement display device according to claim 1, wherein a voice is added at a start of the advertisement to attract attention of users belonging to the same friend group.

5. The advertisement display device according to claim 1, wherein
the advertisement includes educational information, and
additional information or a quiz is displayed by continuing to look at the advertisement.

6. The advertisement display device according to claim 1, wherein synchronously displaying the advertisement has a function of transitioning to a purchase page of the advertisement by a consensus of users belonging to the same friend group.

7. The advertisement display device according to claim 1, wherein synchronously displaying the advertisement has a function of displaying a 3D advertisement object in such a way as to face front side for each user.

8. The advertisement display device according to claim 1, wherein in a case where one of the users belonging to the same friend group looks at the advertisement, synchronously displaying the advertisement includes starting an operation of the advertisement also for other users belonging to the same friend group that are not within a predetermined range, or starting the operation in a case where all the users belonging to the same friend group are within the predetermined range.

9. An advertisement display method for displaying an advertisement in a metaverse space, the method comprising:
confirming positions of a plurality of users and specifying a user within a predetermined range of an advertisement;
specifying users belonging to a same friend group from among users within the predetermined range; and
synchronously displaying an advertisement to users belonging to the same friend group.

10. The advertisement display method according to claim 9, wherein the processor executes stopping an operation of an advertisement in a case where a gaze of the user deviates from the advertisement.

11. The advertisement display method according to claim 10, wherein a gaze of the user is acquired by screen display or gaze tracking.

12. The advertisement display method according to claim 9, wherein a voice is added at a start of the advertisement to attract attention of users belonging to the same friend group.

13. The advertisement display method according to claim 9, wherein
the advertisement includes educational information, and
additional information or a quiz is displayed by continuing to look at the advertisement.

14. The advertisement display method according to claim 9, wherein synchronously displaying the advertisement has a function of transitioning to a purchase page of the advertisement by a consensus of users belonging to the same friend group.

15. The advertisement display method according to claim 9, wherein synchronously displaying the advertisement has a function of displaying a 3D advertisement object in such a way as to face front side for each user.

16. The advertisement display method according to claim 9, wherein in a case where one of the users belonging to the same friend group looks at the advertisement, synchronously displaying the advertisement includes starting an operation of the advertisement also for other users belonging to the same friend group that are not within a predetermined range, or starting the operation in a case where all the users belonging to the same friend group are within the predetermined range.

17. A non-transitory computer-readable medium storing a program for displaying an advertisement in a metaverse space, the program causing an information processing device to execute:
confirming positions of a plurality of users and specifying a user within a predetermined range of an advertisement;
specifying users belonging to a same friend group from among users within the predetermined range; and
synchronously displaying an advertisement to users belonging to the same friend group.

18. The non-transitory computer-readable medium according to claim 17, wherein the processor executes stopping an operation of an advertisement in a case where a gaze of the user deviates from the advertisement.

19. The non-transitory computer-readable medium according to claim 18, wherein the gaze of the user is acquired by screen display or gaze tracking.

20. The non-transitory computer-readable medium according to claim 17, wherein a voice is added at a start of the advertisement to attract attention of users belonging to the same friend group.

21. The non-transitory computer-readable medium according to claim 17, wherein
the advertisement includes educational information, and
additional information or a quiz is displayed by continuing to look at the advertisement.

22. The non-transitory computer-readable medium according to claim 17, wherein synchronously displaying the advertisement includes a function of transitioning to a purchase page of the advertisement by a consensus of users belonging to the same friend group.

23. The non-transitory computer-readable medium according to claim 17, wherein synchronously displaying the advertisement has a function of displaying a 3D advertisement object in such a way as to face front side for each user.

24. The non-transitory computer-readable medium according to claim 17, wherein in a case where one of the users belonging to the same friend group looks at the advertisement, synchronously displaying the advertisement includes starting an operation of the advertisement also for other users belonging to the same friend group that are not within a predetermined range, or starting the operation in a case where all the users belonging to the same friend group are within the predetermined range.
